(19) United States
(12) Patent Application Publication
(10) Pub. No.: US 2021/0390484 A1
(43) Pub. Date: Dec. 16, 2021

(54) METHOD AND APPARATUS FOR COMMUNICATING INFORMATION REGARDING DISTRIBUTED GENERATOR SYSTEMS

(71) Applicant: Enphase Energy, Inc., Petaluma, CA (US)

(72) Inventors: Ayyapu Reddy PALLAM, Kudlu (IN); Samuel MATTATHIL JOSEPH, Bangalore (IN); Rishabh GOEL, Hisar (IN); Sumit SARAOGI, Freemont, CA (US); Ashish BANSAL, Bangalore (IN); Sivakumar RADHAKRISHNAN REMADEVI, Trivandrum (IN); Jayant SOMANI, Saratoga, CA (US); Sujoy GHOSH, Munnekollal (IN); Moumita NASKAR, Devanahalli (IN)

(21) Appl. No.: 17/345,547

(22) Filed: Jun. 11, 2021

Related U.S. Application Data
(60) Provisional application No. 63/038,107, filed on Jun. 11, 2020.

(51) Int. Cl. G06Q 10/06; G06Q 30/02; G06Q 10/04; G06Q 50/06

(52) U.S. Cl. CPC G06Q 10/06315; G06Q 50/06; G06Q 10/04; G06Q 30/0283

(57) ABSTRACT

Method and apparatus for communicating information regarding distributed generator (DG) systems.

### RELATED APPLICATIONS

This application claims benefit to U.S. Provisional Patent Application Ser. No. 63/038,107, filed 11 Jun. 2020 and entitled “End-to-End DG Digital Platform,” which is hereby incorporated herein in its entirety by reference.

### BACKGROUND OF THE INVENTION

### Field of the Invention

Embodiments of the present disclosure relate generally to distributed generator (DG) systems, and, more particularly, to a method and apparatus for communicating information regarding distributed generator systems.

### Description of the Related Art

The current worldwide growth of energy demand coupled with the desire to move away from fossil fuels is leading to increased interest in and deployment of distributed generator (DGs) systems that utilize renewable energy, such as photovoltaic (PV) power systems. Such DG systems typically include power generation devices (e.g., solar panels and power conditioners) and one or more energy storage and delivery devices (e.g., battery storage).

Deployment of DG systems for generating solar power is becoming increasingly widespread and involves a wide range of tasks and communications leading up to system deployment. For example, sales leads must be managed, each potential DG system must be individually designed based on requirements specific to the particular installation site, such as budget, location, system requirements, funding, and the like, and customer proposals must be generated, communicated, reviewed and accepted, rejected or modified. Such activities as well as associated information must be coordinated, communicated and tracked in order to efficiently manage each DG system installation.

Therefore, there is a need in the art for efficiently communicating information regarding DG systems.

### SUMMARY OF THE INVENTION

Embodiments of the present invention generally relate to a digital platform configured as a communications manager for communicating digital information regarding DG systems substantially as shown in and/or described in connection with at least one of the figures, as set forth more completely in the claims.

Various advantages, aspects and novel features of the present disclosure, as well as details of an illustrated embodiment thereof, will be more fully understood from the following description and drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a power generation system in accordance with one or more embodiments of the present invention;

FIG. 2 is a block diagram of a communications manager for communicating information regarding DG systems coupled through a communications network to user devices in accordance with one or more embodiments of the present invention;

FIG. 3 depicts a high-level flow diagram of an example operation of the communications manager of FIG. 2 in accordance with one or more embodiments of the present invention;

FIG. 4 depicts a detailed flow diagram flow diagram of an example operation of the communications manager of FIG. 2 for a consumer user in accordance with one or more embodiments of the present invention;

FIG. 5 depicts a detailed flow diagram flow diagram of an example operation of the communications manager of FIG. 2 for an installer user in accordance with one or more embodiments of the present invention; and

FIGS. 6 through 16 depict example display screens used to facilitate data entry and communication for the communications manager of FIGS. 1 and 2 in accordance with one or more embodiments of the present invention.

### DETAILED DESCRIPTION

Embodiments of the present invention generally relate to a method and apparatus that form a digital platform configured to function as a communications manager for communicating information regarding distributed generator (DG) systems. The device brings DG system stakeholders including: DG system users, potential DG system consumers, DG system component vendor(s) and DG system installers, together on a digital platform that facilitates, controls and manages communications amongst the stakeholders involved in developing, funding and installing DG systems. An end-to-end stakeholder fulfillment process is integrated into a single platform with improved stakeholder experience, reduced soft-cost, and reduced user uncertainty by providing a simple and efficient platform to obtain a DG system solution (e.g., a solar and/or storage solution) with real-time tracking of the development and installation process.

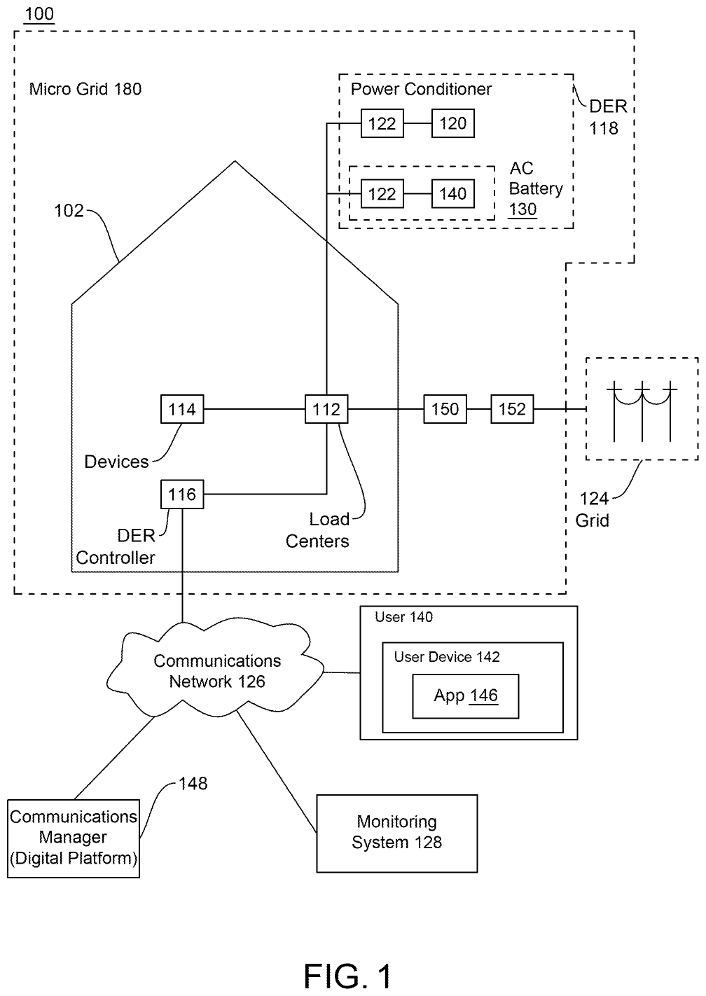

FIG. 1 is a block diagram of a power generation system 100 including a digital platform configured to function as a communications manager for communicating information regarding DG systems in accordance with one or more embodiments of the present invention. This diagram only portrays one variation of the myriad of possible system configurations. The present invention can function in a variety of environments and systems.

The system 100 comprises a DG system 180, e.g., a microgrid 180, that is installed in or on a structure 102, such as a residential or commercial building, having an associated distributed energy resource (DER) 118. The DER 118 is situated external to the structure 102; for example, the DER 118 may be located on the roof of the structure 102. The structure 102 may enclose one or more loads 114 (e.g., appliances, electric hot water heaters, and the like) and a DER controller 116, each coupled to a load center 112. Although the devices 114, the DER controller 116, and the load center 112 are depicted as being located within the structure 102, one or more of these may be located external to the structure 102.

The load center 112 is coupled to the DER 118 via an AC bus 104. The load is also coupled to a utility power grid 124 (e.g., a commercial power grid) via a power meter 152 and a microgrid interconnect device (MID) 150. The DER controller 116, DER 118, load center 112, and MID 150 are part of the DG system 180.

The DER 118 comprises at least one renewable energy source (RES) 120 coupled to at least one power conditioner 122; for example, the DER 118 may comprise a plurality of RESs 120 coupled to a plurality of power conditioners 122 in a one-to-one correspondence or many-to-one correspondence. In embodiments described herein, each RES 120 is a photovoltaic (PV) module, although in other embodiments the RESs 120 may be any type of system for generating power from a renewable form of energy, such as wind, hydro, and the like. The DER 118 may further comprise at least one storage device 140, e.g., battery, chemical, hot water, kinetic, and the like types of energy storage) coupled to at least one power conditioner 122 in a one-to-one or many-to-one correspondence. In one embodiment, each power conditioner 122 battery 140 combination may be referred to as an AC battery 130.

The power conditioners 122 convert the generated DC power from the RESs 120 and/or the storage device 140 to AC power that is power grid-compliant. The generated AC power may be coupled to the power grid 124 via the load center 112 and/or to the loads 114. In addition, the power converters 122 that are coupled to batteries 140 convert AC power from the AC bus 104 to DC power for charging the batteries 140.

In some alternative embodiments, the power conditioners 122 may be AC-AC converters that receive AC input and convert one type of AC power to another type of AC power. In other alternative embodiments, some or all of the power conditioners 122 may be DC-DC converters that convert one type of DC power to another type of DC power and are coupled to a DC bus for delivering the generated DC; in some of such embodiments, the DC-DC converters may be coupled to a main DC-AC inverter for converting the generated DC output to an AC output.

In one embodiment, the power conditioners 122 may communicate with one another and with the DER controller 116 using power line communication (PLC), although, in other embodiments, additionally and/or alternatively other types of wired and/or wireless communication may be used. The DER controller 116 may provide operative control of the DER 118 and/or receive data or information from the DER 118. In various embodiments, the DER controller 116 is a gateway that receives data (e.g., site data, alarms, messages, operating data, performance data, and the like) from the power conditioners 122 (and, in certain embodiments, other components of the DG system 180) and communicates the data and/or other information via the communications network 126 to a DG system monitoring/control platform 128 (e.g., a cloud-based platform) that provides DG monitoring and/or control. The DER controller 116 may also send information to the power conditioners 122, such as control signals generated by the DER controller 116 or received from a remote device or a DG monitoring/control platform. The DER controller 116 may be communicably coupled to the communications network 126 via wired and/or wireless techniques; for example, the DER controller 116 may be wirelessly coupled to the communications network 126 via a commercially available router. In one or more embodiments, the DER controller 116 comprises an application-specific integrated circuit (ASIC) and/or microprocessor along with suitable software for performing one or more of the functions described herein.

The meter 152 may be any suitable energy meter that measures the energy consumed by the DG system 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (kVAR), grid frequency, and grid voltage.

The MID 150, which may also be referred to as an island interconnect device (IID), may comprise a disconnect component (e.g., a contactor or the like) for physically connecting/disconnecting the DG system 180 to/from the grid 124. In some embodiments, the DER controller 116 receives information regarding the present state of the system from the power conditioners 122 and the energy consumption values of the DG system 180 from the meter 152 (for example via one or more of PLC, other types of wired communication, and/or wireless communication) and, based on these inputs, determines when to go on/off-grid and instructs the MID 150 accordingly. In other embodiments, the MID 150 comprises an ASIC and/or CPU, along with suitable software (e.g., an islanding module) for determining when to disconnect from/connect to the grid 124; for example, the MID 150 may monitor the grid 124 and detect a grid fluctuation, disturbance or outage and, as a result, disconnect the DG system 180 from the grid 124. Once disconnected from the grid 124, the DG 180 can continue to generate power as an intentional island without imposing safety risks, for example on any line workers that may be working on the grid 124.

In some alternative embodiments, the MID 150 or a portion of the MID 150 is part of the DER controller 116 or apportion of the load center 112. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or separate. In some embodiments, the MID 150 may communicate with the DER controller 116 (e.g., using wired techniques such as power line communications, or using wireless communication) for coordinating connection/disconnection to the grid 124.

A user 140 (e.g., homeowner, business owner, DG system manager, and the like) may access the DER controller 116 and/or the monitoring platform 128 via the communications network 126 (e.g., the Internet) to receive functionality information and/or reports. The user 140 accesses the network through a user device 142 that executes and software application (app 146). The user device may be a handheld device such as a smart phone or tablet or be a desktop or laptop computer.

The DG system 180 is one example of a DG system that can be implemented utilizing a digital platform 148 for communicating information amongst DG system stakeholders. In accordance with one of more embodiments of the present invention, the digital platform 148 communicates information regarding the development and installation of the DG system amongst potential DG system consumers, DG system users, DG system component vendor(s) and DG system installers (i.e., DG system stakeholders). The information includes pre-sales end-to-end system sizing, installer matching, tracking and deal closure information regarding development and installation of a DG system. The end-to-end stakeholder process is integrated into a single platform with improved customer experience, reduced soft-cost, and reduced user uncertainty by providing a simple and efficient platform to develop and install a DG solution (e.g., a solar and storage solution) and provide real-time tracking of the process. Additionally, the digital platform 148 may be utilized for changes to existing DG systems, e.g., adding additional equipment.

The digital platform 148 (configured to function as a communications manager) is a cloud-based computing platform communicatively coupled to the communications network 126; in other embodiments, the digital platform 148 may be remote device or system such as a master controller (not shown), and the like. A user 140 may utilize a user device 142 (such as a mobile device or computer) communicably coupled by to the communications network 126. As described in detail below, the user device 142 may access the digital platform through execution of application software (app 146) or through a web browser. Users of the digital platform 148 include consumers (current and potential) of DG systems (consumer users), DG system component vendors and DG system installers (installer users). Through interaction with the digital platform 148, a consumer user may investigate DG systems, define a system, order DG system components, communicate with one or more installers, arrange for an installer to install a system, and the like. While an installer user may be introduced to a consumer (i.e., sales lead generation), manage leads, provide DG system quotes, interact with consumers, close a sale, schedule installation, and the like. In addition, DG system components may be ordered from component vendor on-line stores. All information involved in all these tasks is coordinated and controlled by the digital platform 148 in accordance with at least one embodiment of the invention.

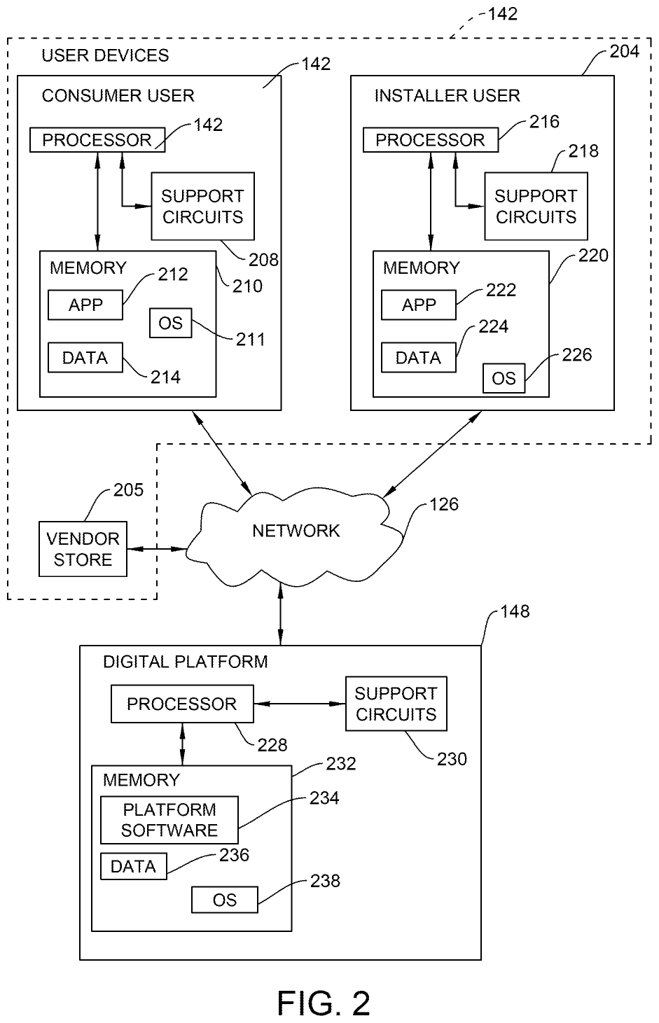

FIG. 2 is a block diagram of a system 200 comprising the digital platform 148 for communicating information regarding DG systems coupled through a communications network 126 to user devices 142 in accordance with one or more embodiments of the present invention. In one embodiment, the user devices 142 comprise one or more consumer devices 202, one or more installer devices 204 and one or more vendor on-line stores 205. In one exemplary embodiment, the digital platform 148 facilitates, controls and manages communication of information amongst the user devices 142 (i.e., stakeholders) regarding the design, development and installation of a DG systems. The information that is communicated may include, but not be limited to, DG system designs, costs estimates, acknowledgements, notices, offers, acceptances, rejections, contracts, and the like.

In one embodiment, the one or more consumer device 202 comprises at least one processor 206, support circuits 208 and memory 210. The at least one processor 206 may be any form of processor or combination of processors including, but not limited to, central processing units, microprocessors, microcontrollers, field programmable gate arrays, graphics processing units, and the like. The support circuits 208 may comprise well-known circuits and devices facilitating functionality of the processor(s). The support circuits 208 may comprise one or more of, or a combination of, power supplies, clock circuits, communications circuits, cache, and the like.

The memory 210 comprises one or more forms of non-transitory computer readable media including one or more of, or any combination of, read-only memory or random-access memory. The memory 210 stores software and data including, for example, an operating system (OS) 211, application software 212, and data 214. The operating system 211 may be any form of operating system such as, for example, Apple iOS, Microsoft Windows, Apple macOS, Linux, Android or the like. The application software 212 may be software that, when executed by the processor(s) 210, is capable of displaying and enabling user interaction with the digital platform 148. In some embodiments, the application software 212 may be a web browser. Such browsers include, but are not limited to, Explorer, Safari, Chrome, Edge, Firefox or the like. The data 214 may include a web page, or portion thereof, data used by a web page, data entered by a user into fields within the application 212 and/or any other data used by the application 212 to display and facilitate user interaction and communication with the digital platform 148.

In one embodiment, the installer device 204 comprises at least one processor 216, support circuits 218 and memory 220. The at least one processor 216 may be any form of processor or combination of processors including, but not limited to, central processing units, microprocessors, microcontrollers, field programmable gate arrays, graphics processing units, and the like. The support circuits 208 may comprise well-known circuits and devices facilitating functionality of the processor(s). The support circuits 218 may comprise one or more of, or a combination of, power supplies, clock circuits, communications circuits, cache, and/or the like.

The memory 220 comprises one or more forms of non-transitory computer readable media including one or more of, or any combination of, read-only memory or random-access memory. The memory 220 stores software and data including, for example, an operating system (OS) 226, application software 222, and data 224. The operating system 211 may be any form of operating system such as, for example, Apple iOS, Microsoft Windows, Apple macOS, Linux, Android or the like. The application software 222 may be software that, when executed by the processor(s) 210, is capable of displaying and enabling user interaction and communication with the digital platform 148. In some embodiments, the application software 222 may be a web browser. Such browsers include, but are not limited to, Explorer, Safari, Chrome, Edge, Firefox or the like. The data 224 may include a web page, or portion thereof, data used by a web page, data entered by a user into fields within the application 222 and/or any other data used by the application 222 to display and facilitate user interaction and communication with the digital platform 148.

The one or more vendor store 205 is accessed by the consumer and/or installer devices through the platform 148 to facilitate ordering, purchasing and delivering DG system components. A consumer may upgrade or add onto a currently owned DG system through interaction with the platform 148 and the vendor store 205. Additionally, as is described below in detail, a consumer may design and purchase a turnkey DG system where the installer will purchase the DG system components from the store 205 and install the components. Alternatively, a consumer may design a DG system, purchase the components from the store 205 and use the platform to arrange for installation (i.e., a non-turnkey DG system).

In one embodiment, the digital platform 148 comprises at least one processor 228, support circuits 230 and memory 232. The at least one processor 228 may be any form of processor or combination of processors including, but not limited to, central processing units, microprocessors, microcontrollers, field programmable gate arrays, graphics processing units, and the like. The support circuits 208 may comprise well-known circuits and devices facilitating functionality of the processor(s). The support circuits 230 may comprise one or more of, or a combination of, power supplies, clock circuits, communications circuits, cache, and/or the like.

The memory 232 comprises one or more forms of non-transitory computer readable media including one or more of, or any combination of, read-only memory or random-access memory. The memory 232 stores software and data including, for example, an operating system (OS) 238, platform software 234, and data 236. The operating system 236 may be any form of operating system such as, for example, Microsoft Windows, Microsoft Windows Server, Apple macOS, Linux, or the like. The platform software 234 may be software that, when executed by the processor(s) 228, is capable of displaying and enabling users to communicate with one another regarding the development and installation of DG systems. In some embodiments, the platform software 212 may include, in part, a web server software to facilitate user interaction with a web site. The data 236 may include a web page, or portion thereof, data used by a web page, data entered by a user into fields within the application 212 or 222 and/or any other data used by the platform software 234 to display and facilitate user interaction and communication with the digital platform 148.

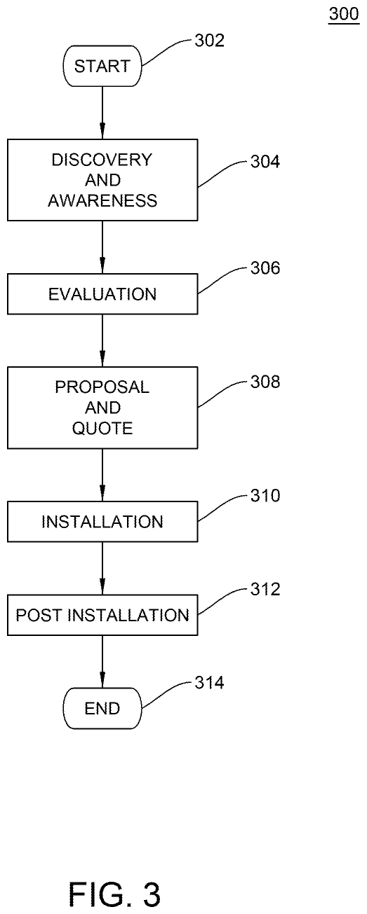

FIG. 3 depicts a high-level flow diagram of an example operation of the digital platform 148 of FIGS. 1 and 2 configured to function as a communications manager in accordance with one or more embodiments of the present invention. Any block, step, module, or otherwise described below may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e. within tolerances of the systems executing the block, step, or module. Of course, such blocks are presented for illustration purposes only and any one or more block, step, or module may be combined with any other, removed, split, or moved between the various systems and subsystems illustrated.

The example operation is represented as a method 300 that begins at 302 and proceeds to 304. At 304, discovery and awareness is performed such that a consumer user may interact with the platform to discover the types and sizes of DG systems that are available. The user may utilize a system capacity estimator such as is described in U.S. patent application Ser. No. 63/041,102, filed 18 Jun. 2020, entitled “Capacity Estimator for an Energy Generation and/or Storage System,” (the '102 application) and U.S. patent application Ser. No. 63/084,827, filed 29 Sep. 2020, entitled “Capacity Estimator for an Energy Generation and/or Storage System,” (the '827 application) which are both hereby incorporated herein in their entireties. Such a capacity estimator enables a user to graphically define a DG system while exploring various system layouts and capabilities.

At 306, the user may evaluate the DG system design to gauge the amount of energy to be generated and/or stored. At this point, the platform also suggests one or more installers that are available to either install a turnkey DG system or install system components that the consumer is considering purchasing. For a turnkey system, the installer will purchase the system components and install them as a service to the consumer.

For a non-turnkey system, the consumer user purchases the system components, and an installer user is separately hired to install the purchased components. At 306, the consumer user evaluates the DG system design as well as the suggested installers. The user may request a quote and proposal from one or more of the suggested installers.

At 308, the one or more installer users may respond to the request for a proposal and quote by sending such to the consumer user. Within the platform, documents may be electronically exchanged, negotiated, accepted, rejected, and/or executed. Communication of information amongst all stakeholders is facilitated in a scripted and organized fashion by the platform.

Assuming a proposal is accepted, at 310, the DG system is installed by the selected installer. At 312, if the installer provided a turnkey system, the installer may provide post installation services such as system monitoring and/or maintenance. If the installation was a non-turnkey arrangement, then the consumer may pay for additional post installation services or may choose to handle DG system monitoring and maintenance themselves. Throughout all steps of the process, the platform provides a graphical indication of the process status. The method 300 ends at 314. The platform provides communication channels amongst the stakeholders (consumer, installer, vendor, etc.) to facilitate design, development, and installation of a DG system.

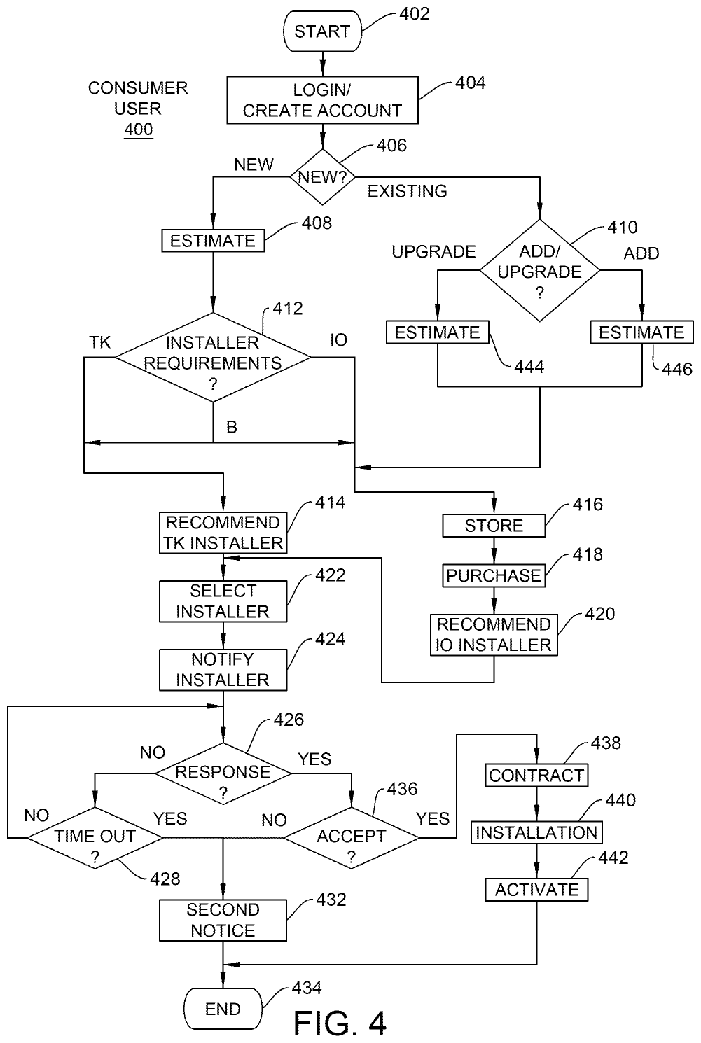

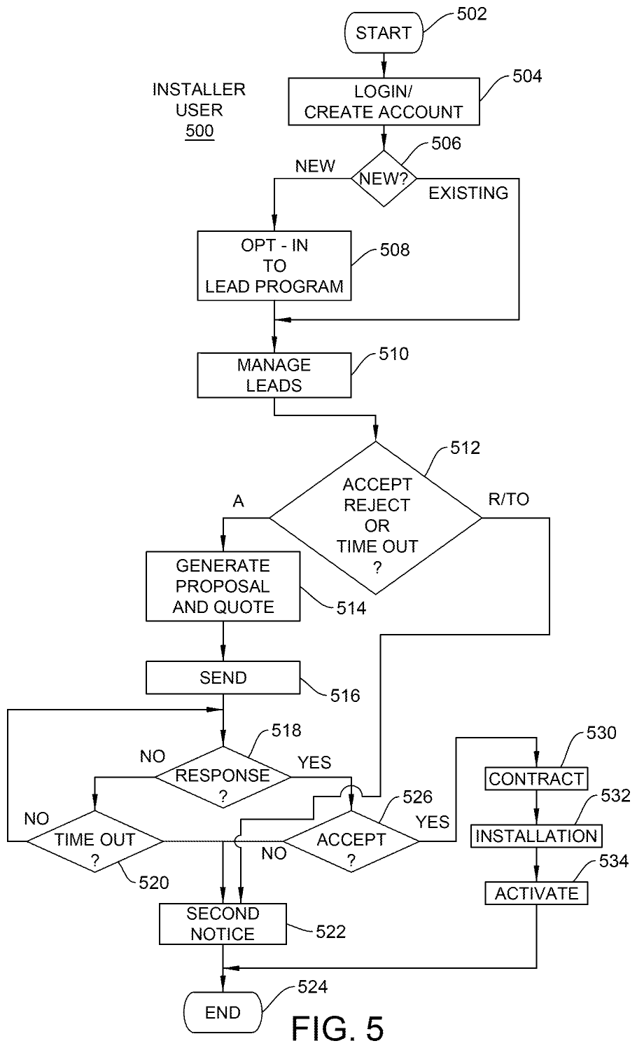

FIGS. 4 and 5 depict a detailed flow diagram flow diagram of an example operation of the digital platform 148 of FIGS. 1 and 2 configured to function as a communications manager in accordance with one or more embodiments of the present invention. FIG. 4 depicts a flow diagram of platform operation in support of a consumer user (method 400) and FIG. 5 depicts a flow diagram of platform operation in support of an installer user (method 500). Any block, step, module, or otherwise described below may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module. Of course, such blocks are presented for illustration purposes only and any one or more block, step, or module may be combined with any other, removed, split, or moved between the various systems and subsystems illustrated.

The example consumer user centric operation is represented by method 400 which begins at 402 and proceeds to 404 where the consumer may login to their account or create a new account for accessing the platform 148. At 406, the method 400 queries whether the consumer is investigating a purchase of a DG system (new) or is investigating adding or upgrading components of an existing system (existing). If the query is answered “new,” the method 400 proceeds to 408; otherwise, the method 400 proceeds to 410.

At 408, the method 400 allows the user to interactively design a DG system using, for example, a system design tool such as a capacity estimator of the type described in the '102 and '827 applications. Other techniques may be used for estimating system size (e.g., number and type of components in the form of a bill of materials (BOM)). From the BOM, the method generates an estimate for the cost to purchase a turnkey (TK) system (e.g., including all components, installation services and post-installation monitoring), an install only (IO) system (e.g., including component estimation only), or both TK and IO estimates.

At 412, the method 400 queries the user whether they are looking at a TK system, an install only system, or both. If TK, the method 400 proceeds to 414 where the method 400 displays one or more suggested TK system installers.

If the user selected install only, they have the opportunity to shop now and purchase the equipment for their install. As such, a link to one or more equipment vendor web stores may be available or the platform may have a built-in webstore. At 416, the method presents the store wherein a user may select products to fulfill the estimated system from 408. At 418, the user may purchase the components of a DG system from the store.

Once the system components are purchased, the method 400 proceeds to 420 where the method displays one or more installers that are capable of installing equipment that has been purchased. If the user is unsure of whether they wish to purchase a TK system or an 10 system, they may select “both” and have the method 400 suggest both TK installers and 10 installers. The method 400 selects particular installers for display based on various factors such as, but not limited to, proximity to the consumer, experience installing the type of system created at 408, availability to perform an installation, type of system created at 408, experience installing at the type of facility (e.g., commercial, residential, etc.) where the DG system is to be installed, and the like. If install only, the method 400 proceeds to 416 where the method displays one or more installers that are capable of installing equipment that the user purchases on their own. If the user is unsure of whether they wish to purchase a TK system or an IO system, they may select “both” and have the method 400 suggest both TK installers and IO installers. The method 400 selects particular installers for display based on various factors such as, but not limited to, proximity to the consumer, experience installing the type of system created at 408, availability to perform an installation, type of system created at 408, experience installing at the type of facility (e.g., commercial, residential, etc.) where the DG system is to be installed, and the like.

At 422, the user selects one or more installers for either TK installation, IO installation or both. Upon selection, at 424, the method 400 sends a notice to the user selected installers. The notice may include a messaging or chat session through which the installer user and consumer user may discuss the DG system, the facility at which it will be installed, and the like.

At 426, the method 400 queries whether a response to the notice has been received. If the query is negatively answered, the method 400 proceeds to 428 to determine if a time limit (e.g., 48 hours) for response has been exceeded (timed out). If the time limit has not been exceeded, the method proceeds to 426. If the time limit has expired, the method 400, at 432, notifies the consumer user that the installer has not responded to the notice. The method ends at 434. If a response has been received at 426, the method proceeds to 436. At 436, the method 400 queries whether the response is an acceptance or rejection of the selection of the installer. If the installer rejects the consumer's request, a notice is sent to the consumer user at 432 and the method 400 ends at 434.

If the installer has accepted the request, the method 400 generates a contract at 438. The contract is an electronic document that is sent to the consumer and installer. The document may be signed electronically.

At 440, the method 400 tracks the installation process and updates a process status indicator to show the consumer and installer the status of installation. At 442, the method 400 may communicate to the consumer and installer information regarding activation of the DG system. The method ends at 434.

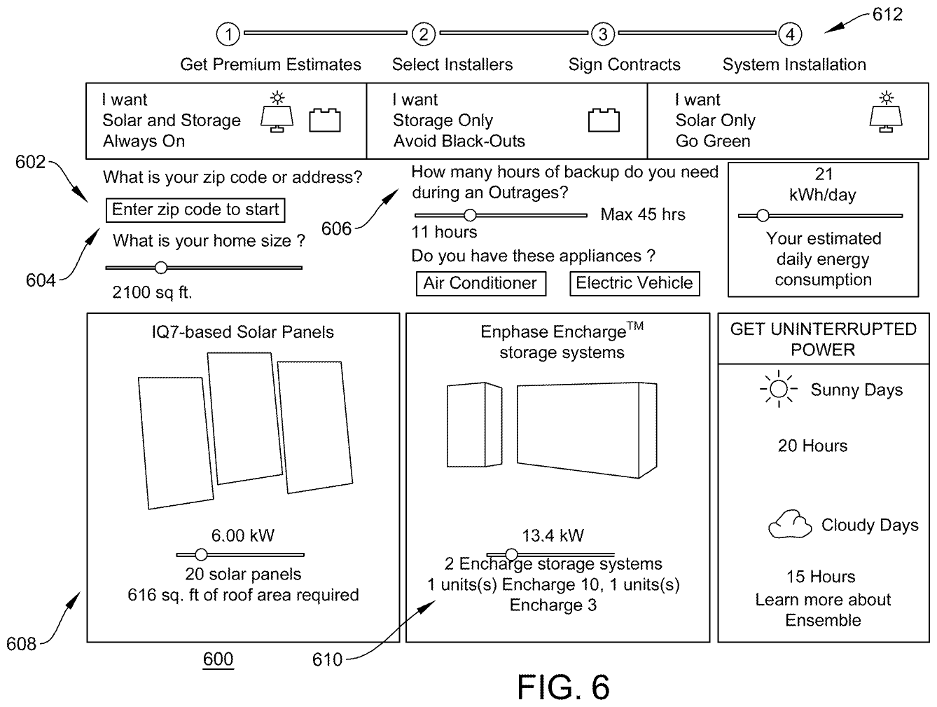

At 406, if the consumer has selected that they have an existing system, the method 400 proceeds to 410 where the method queries whether the consumer wishes to add components to their existing system (e.g., add additional solar panels, add energy storage, etc.) or upgrade existing components (e.g., replace existing solar panels, inverters, cabling, energy storage, etc.). If the user selects an upgrade, at 444, the method 400 enables the user to explore upgrade options and provides the necessary bill of materials and an estimated cost. If the user selects to add components, at 446, the method 400 enables the user to explore new equipment options and provides the necessary bill of materials and an estimated cost. From 444 or 446, the method 400 proceeds to 416 and 418, where the on-line store may be entered to enable the consumer to select and purchase the added or upgrade components. At 420, the suggested IO installer may include an installer that is currently handling the existing system account. Alternative installers may also be presented. The method 400 proceeds at 422 as described above. Throughout the process, the digital platform communicates information to the consumer user regarding status of the process. In one embodiment, the status information is displayed as a status bar with process milestones identified in a timeline format. The details of the consumer user communications displays are described in detail with respect to FIGS. 6 through 12 below.

As shown in FIG. 5, an installer user enters an installer centric method 500 at 502 and proceeds to 504 where the installer either logs in to an existing account or creates a new account. At 506, the method 500 queries whether the account is new or not and, if new, at 508, the installer is requested to opt-in to the lead program through which the platform will automatically communicate sales leads to the installer. The opt-in procedure may require the installer to agree to provide certain types of services and support of customers as well as identify the types of equipment and components the installer desires or is capable of installing (e.g., storage systems, solar systems, perform upgrades to existing equipment, etc. Also, the installer may be required to identify themselves as a turnkey installer or an install only installer as well as opt-in for providing operations and maintenance support or not. Additionally, the installer may also elect to purchase system components from one or more specific vendors (i.e., from their on-line stores).

If the query at 506 indicates an existing account, then 508 may be skipped and the method 500 proceeds to 510. At 510, the method 500 facilitates lead management. When a consumer user selects an installer at 422 in FIG. 4, the lead notice is sent to the installer and displayed in a lead management list. The lead management list comprises, for example, the names, addresses, lead status, quote amount and the like. At 512, the installer user has an opportunity to accept the notice, reject the notice or do nothing and allow the notice to time out (i.e., effectively a rejection).

If the installer user elects to accept the request for a quote, at 514, an acceptance notice, proposal and quote may be generated and, at 516, sent to the consumer user. At 436 in FIG. 4 described above, the consumer user has an opportunity to reject or accept the installer's response. At 518 and 520, the method 500 waits for a response from the consumer (e.g., 48 hours). Specifically, the query at 518 looks for a response (i.e., accept or reject). If no response has arrived, the method 500 queries if a time limit has been exceeded to indicate no response has been received for an extended period. If the time limit has been exceeded, the method 500 proceeds to 522 to send a notice to the installer user that a response has not been received and the proposal is assumed rejected. If the time limit is not exceeded, the method 500 proceeds from 520 to 518.

If a response is received at 518, the method 500 proceeds to 526 where the method 500 queries whether the proposal has been rejected or accepted. If the quote is rejected, at 522, a notice is sent to the installer user indicating the rejection and the method 500 ends at 524. If, at 526, the quote is accepted, the method 500 at 530 generates a contract that may be electronically executed by the installer user and the consumer user within the platform environment. At 532, the installation process is monitored and reported to the consumer user and installer user. At 534, after installation is complete, the method 500 communicates that the DG system has been activated and ends at 524.

If at 512 the installer rejects the request for a quote or does not respond to the consumer user's request for a quote causing a time out to occur, the method 500 proceeds to 522 and sends a notice to the consumer user rejecting the request and the method ends at 524.

FIGS. 6 through 16 depict example display screens used to facilitate data entry and communication for the digital platform of FIGS. 1 and 2 configured to function as a communications manager in accordance with one or more embodiments of the present invention. FIG. 6 depicts an exemplary DG system estimator screen 600 that may be displayed to a consumer user during the DG estimation phase of the method of FIG. 4. The DG system estimator may operate in accordance with the description in the '102 and '827 applications referred to above. Based upon the location of the facility, the size of the facility, and the amount of backup hours required (entered into fields 602, 604, and 606, respectively), the estimator identifies the DG system components required to fulfill the requirements. Specifically, in the exemplary screen 610, the number of solar panels are displayed at 608 and the amount of storage is displayed at 610. A status bar 612 communicates the progress to the consumer user during the process of designing, developing, purchasing and installation of a DG system.

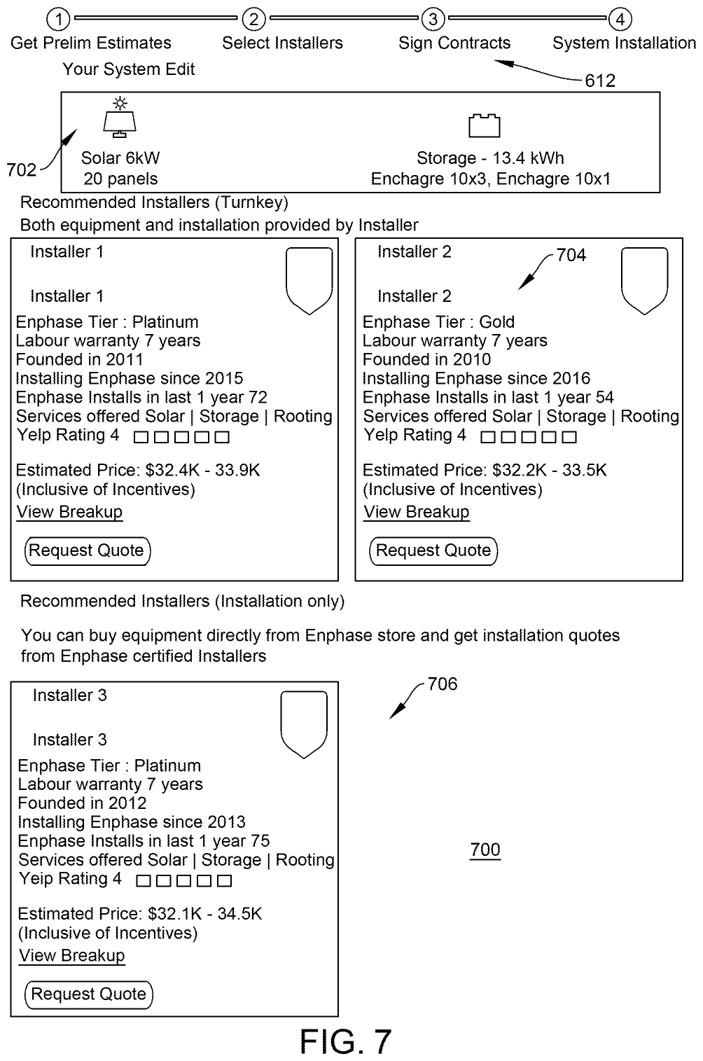

FIG. 7 depicts an exemplary recommended installer screen 700 that may be displayed to communicate the recommended installer information as generated in method 400 of FIG. 4 in accordance with one or more embodiments of the invention. In the depicted exemplary embodiment, the screen 700 comprises a region 702 displaying the DG system estimated size (e.g., number of solar panels and amount of storage), a region 704 displaying the installer information of at least one turnkey system installer, and region 706 displaying the installer information of at least one installation only installer. In screen 700, the status bar 612 is updated to communicate to the consumer user that the process is now in the “select installer” phase. In this phase, the consumer user may select one or more installers from the recommended installers and the platform notifies the installer regarding their selection.

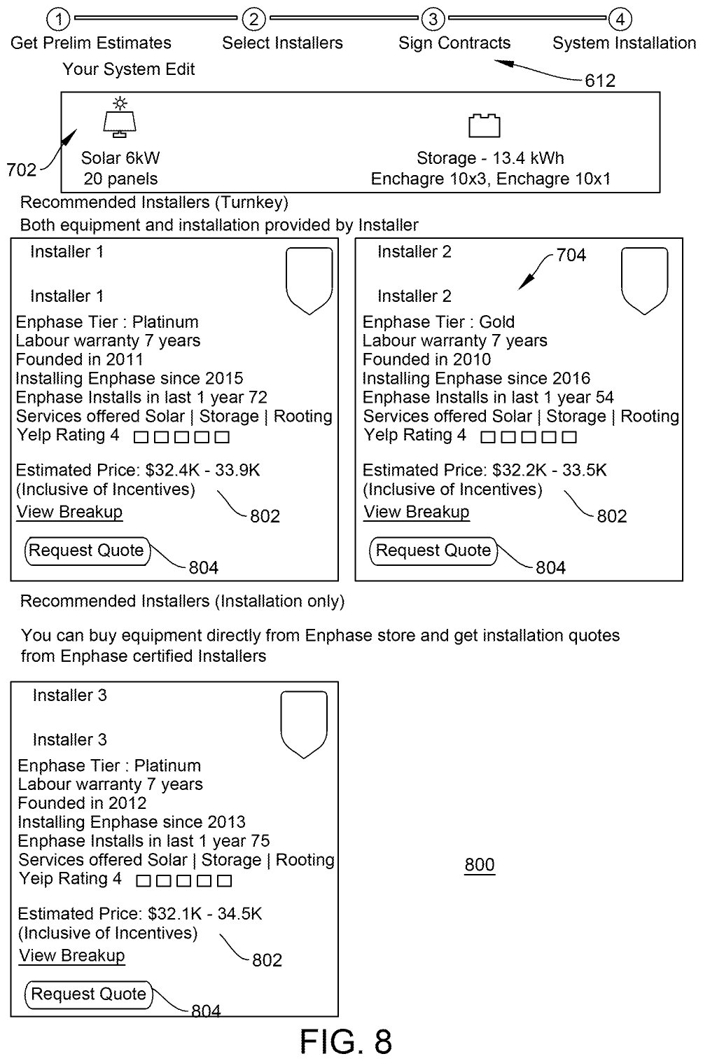

FIG. 8 depicts an exemplary recommended installer screen 800 that may be displayed to communicate that quotes have been received as generated in method 400 of FIG. 4 in accordance with one or more embodiments of the invention. Screen 800, in addition to the regions of FIG. 7, comprises a region 802 displaying a quoted amount as received from each installer and a region 804 displaying the status of the interaction with a given installer (e.g., quote received, request for quote rejected, no response, awaiting response, etc.). To view details of a specific quote, the consumer user may select “View Details” in region 804.

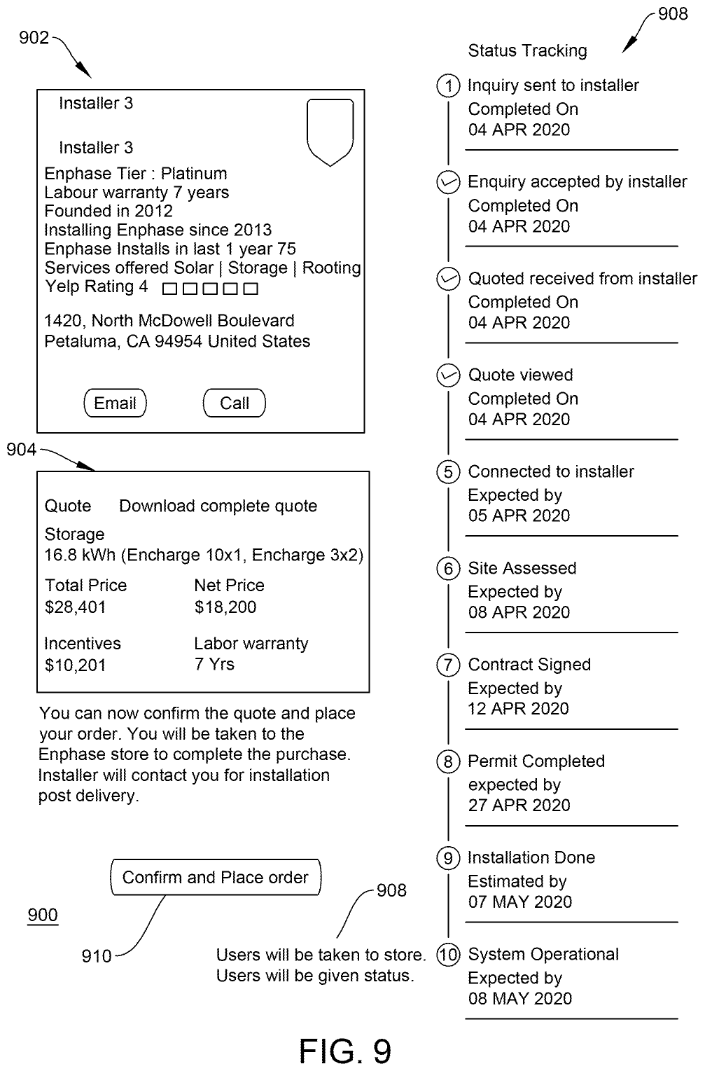

FIG. 9 depicts an exemplary quote details screen 900 that may be displayed to communicate the details of a particular quote upon the consumer user selecting “view Details” in screen 800 in accordance with one or more embodiments of the invention. Screen 900 comprises a region 902 displaying details regarding the installer (e.g., years in business, founding year, address, warranty information, email address, phone number, etc.), a region 904 displaying quote details (e.g., price, warranty, components, incentives, etc.) and a status bar 906 that tracks project status (e.g., inquiry sent to installer, inquiry accepted, quote received, quote viewed, connected to installer, site assessed, contract signed, permit completed, installation completed, system operational, etc.). The displayed installer information in the example screen 900 is for an installation only installer. As such, the screen 900 includes a link 908 to a vendor store such that the consumer user may purchase the components listed in the quote. The screen 900 may also include a button 910 to enable the consumer user to confirm and place the order. Such selection will lead to a contract being generated and sent to the user.

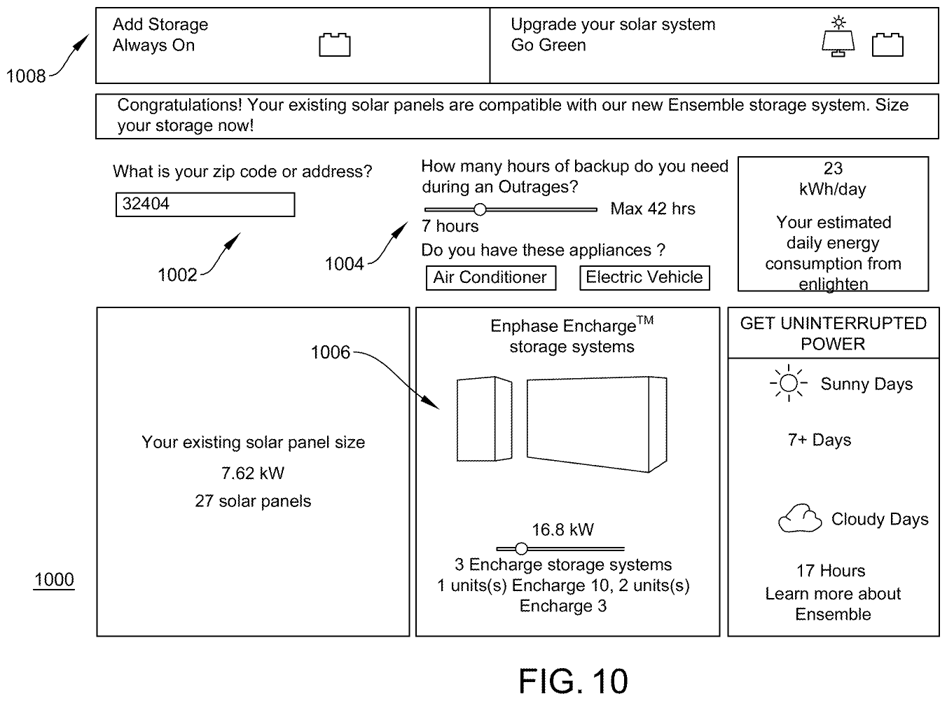

FIG. 10 depicts an exemplary add to/upgrade system screen 1000 that may be displayed to facilitate using a system estimator to identify components to add or upgrade an existing system in accordance with one or more embodiments of the invention. In the depicted embodiment, the screen 1000 is used to add storage to an existing DG system, where the screen 1000 comprises a region 1002 to enter the facility location, a region 1004 to enter requirement information to define the component to be added (e.g., enter a number of hours of backup required, loads to be backed up, etc.) and a region 1006 displaying recommended components to fulfill the requirements entered in region 1004. The screen 1000 further comprises a selectable region 1008 through which a consumer user may select to add storage to their existing DG system or upgrade components of their existing DG system.

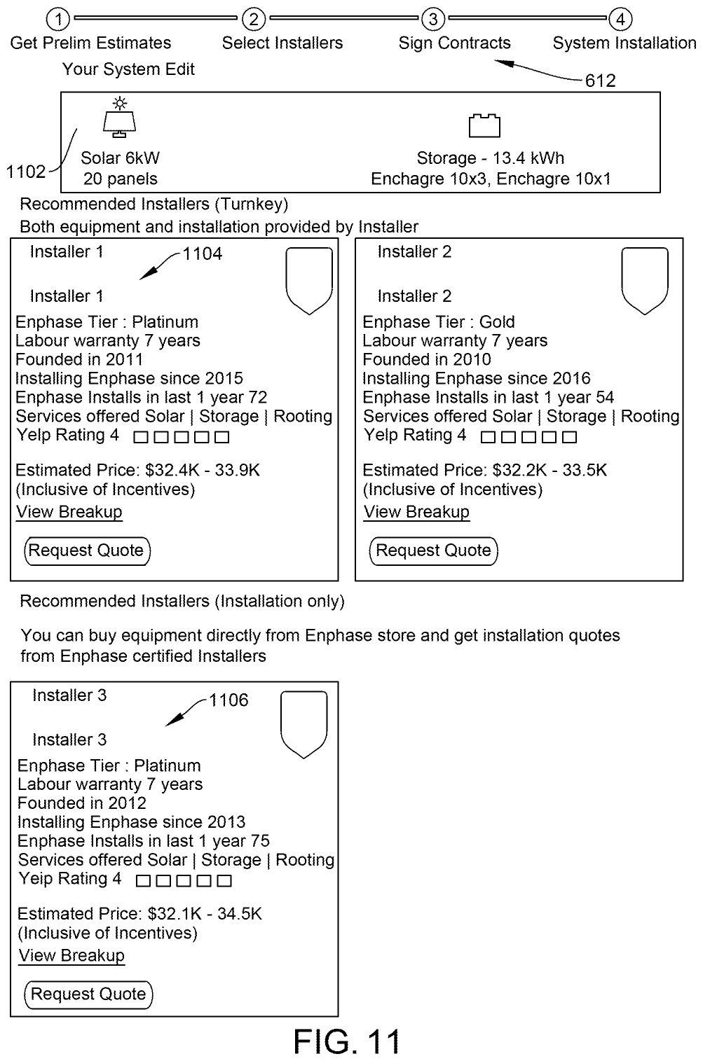

FIG. 11 depicts an exemplary recommended installer screen 1100 that may be displayed to communicate recommended installer information for performing the upgrade define using screen 1000 of FIG. 10 in accordance with one or more embodiments of the invention. Screen 1100 may comprise a region 1102 displaying the component to be upgraded or added, a region 1104 displaying turnkey upgrade installer information, a region 1106 displaying installation only installer information and the status bar 612.

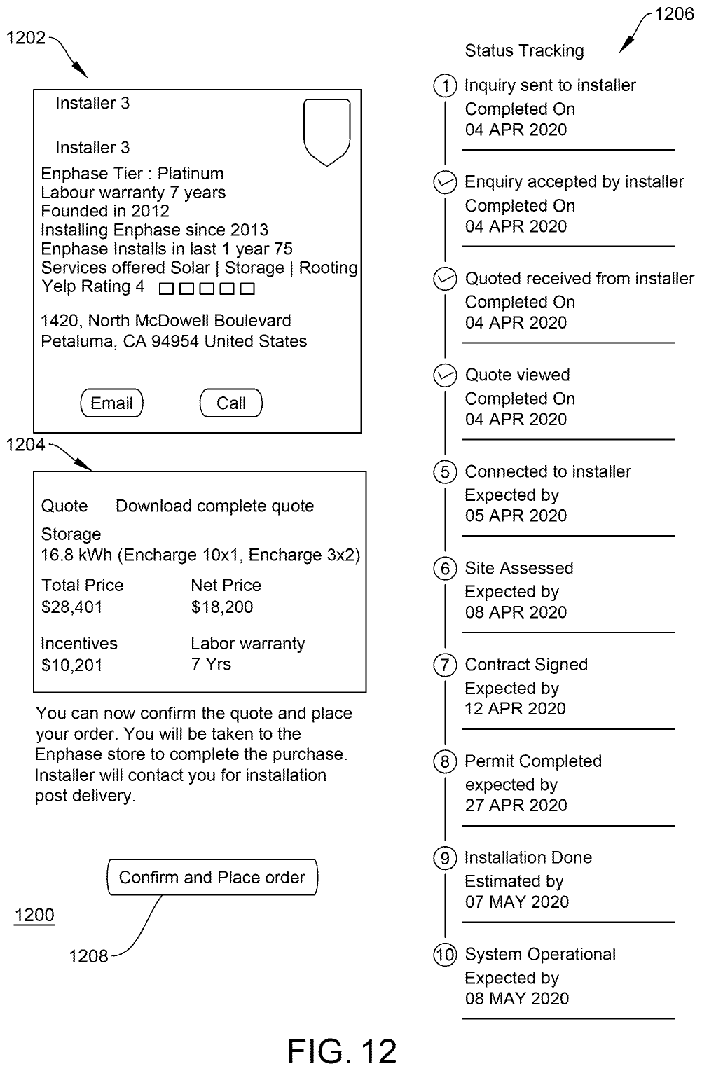

Upon selection of one of the installer information regions in screen 1100 of FIG. 11, screen 1200 of FIG. 12 is displayed to communicate details of the recommended installer (region 1202), quote details (region 1204), project status bar 1206 and a button 1208 to facilitate confirmation and placement of the order. Screen 1200 is substantially similar to screen 900 in FIG. 9 as described above.

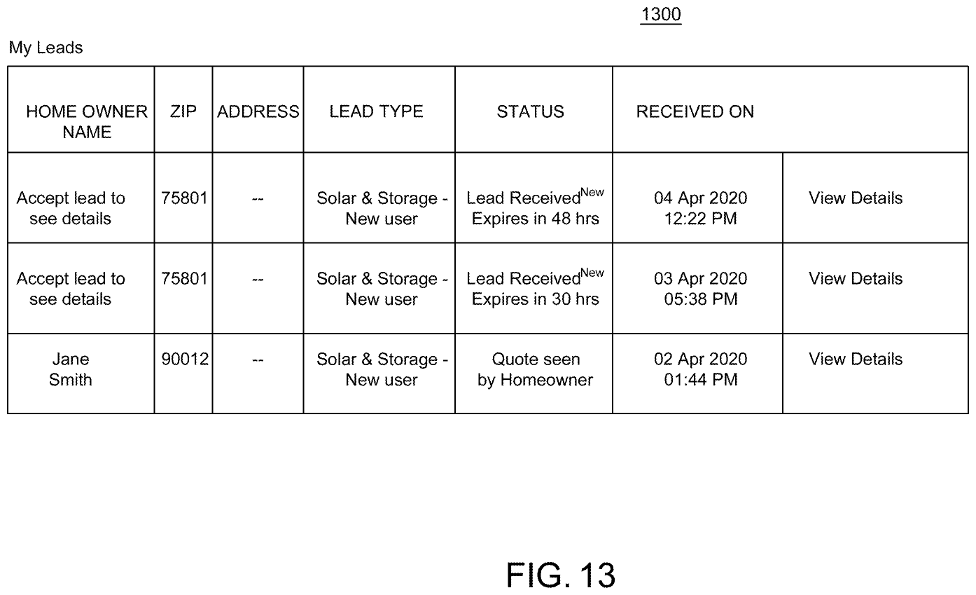

FIG. 13 depicts a screen 1300 comprising the leads list that is generated by the method 500 in FIG. 5 in accordance with at least one embodiment of the invention. Screen 1300 communicates to the installer user information about each lead provided by the platform. The lead information may include, but is not limited to, the leads name, address, lead type (e.g., DG system, upgrade, existing customer, new customer, etc.), lead status (e.g., lead received, lead accepted, quote sent, quote accepted, etc.), lead date, and the like. The lead information may also include a view details link to link to a page of details regarding a specific lead.

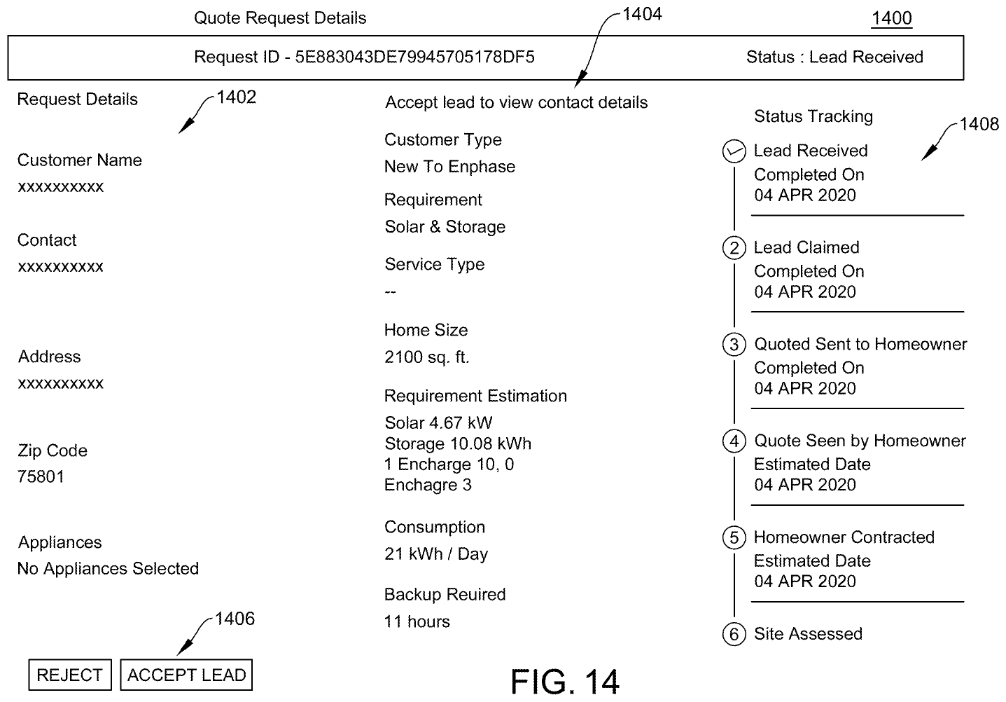

FIG. 14 depicts a screen 1400 communicating details of a specific lead to the installer user in accordance with at least one embodiment of the invention. Screen 1400 comprises a region 1402 displaying customer information (e.g., name, contact information, location, etc.) and a region 1404 displaying the DG system requirements generated by the consumer user using, for example, the system estimator screen 600 of FIG. 6. Region 1406 comprises buttons to accept or reject the lead. Region 1408 comprises a lead status bar communicating the current status of the project associated with the particular lead.

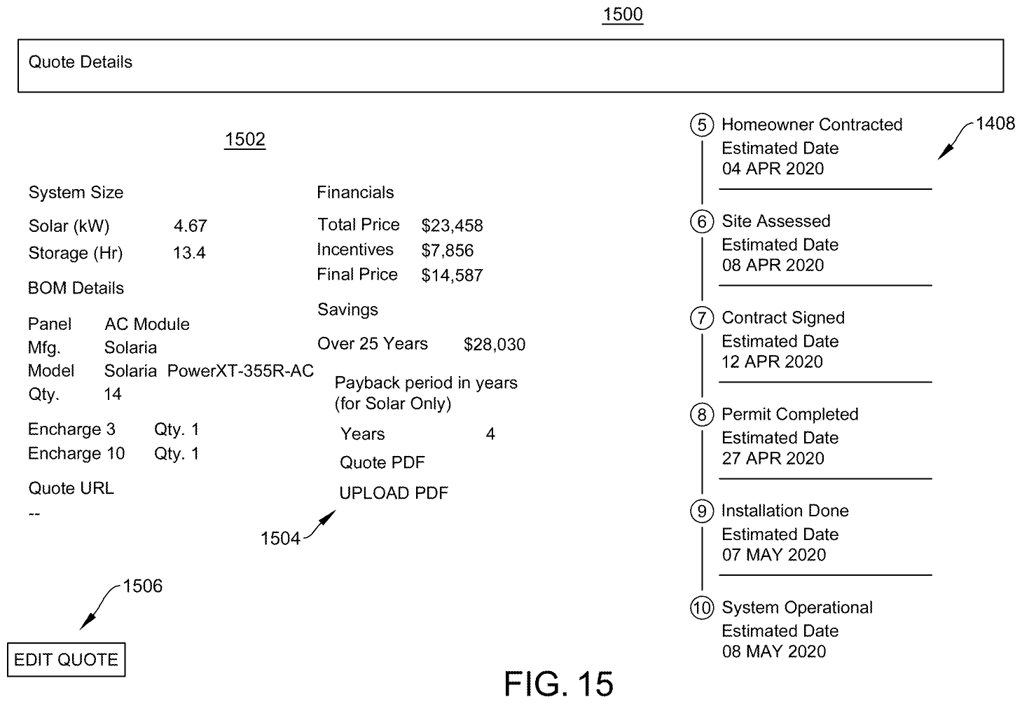

FIG. 15 depicts a screen 1500 through which an installer user may prepare a quote for a particular lead and submit the quote to the consumer user in accordance with at least one embodiment of the invention. Screen 1500 may comprise a region 1502 displaying fields for entry of quote details (e.g., system specifications, bill of materials details, financial information, etc.), a button 1404 to enable uploading/linking to a pdf of the quote, a region 1506 containing control buttons to enable submitting (communicating) a quote to a consumer user (lead) or resetting the quote detail information. The screen 1500 further comprises the status bar 1408.

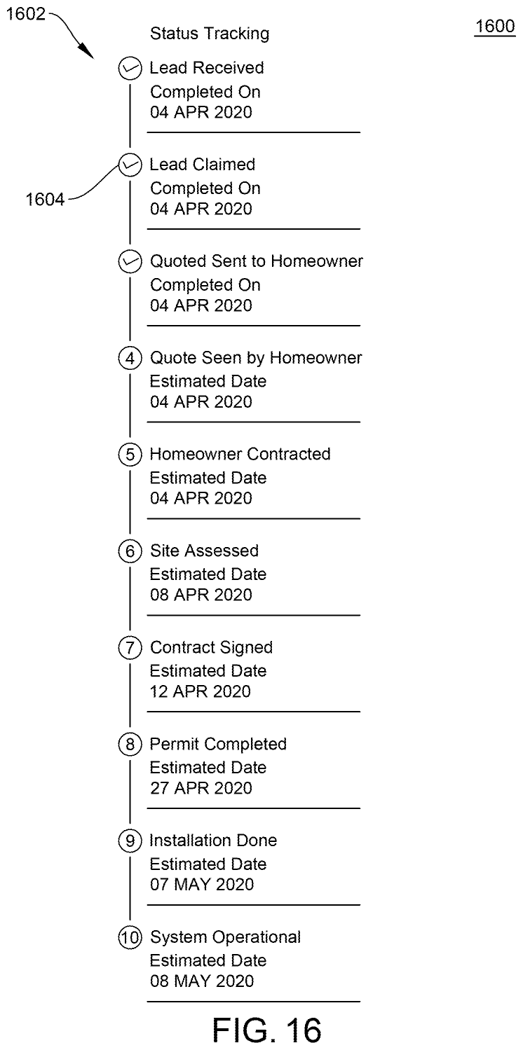

FIG. 16 depicts a screen 1600 for communicating a current status of a particular DG system project to an installer user in accordance with at least one embodiment of the invention. Screen 1600 may comprise a status bar 1602 listing each phase of a project and an indicator 1604 as to whether each phase is complete. A date of completion may also be included. The indicator, in the depicted embodiment, is a check mark to indicate completion of a phase. However, other indicators may be used in substitution or in addition to the check mark such as color change, completion date display, other text or graphical indicators, etc.

Here multiple examples and embodiments have been given to illustrate various features and are not intended to be so limiting. Any one or more of the features may not be limited to the particular examples presented herein, regardless of any order, combination, or connections described. In fact, it should be understood that any combination of the features and/or elements described by way of example above are contemplated, including any variation or modification which is not enumerated, but capable of achieving the same. Unless otherwise stated, any one or more of the features may be combined in any order.

As above, figures are presented herein for illustrative purposes and are not meant to impose any structural limitations, unless otherwise specified. Various modifications to any of the structures shown in the figures are contemplated to be within the scope of the invention presented herein. The invention is not intended to be limited to any scope of claim language.

Where “coupling” or “connection” is used, unless otherwise specified, no limitation is implied that the coupling or connection be restricted to a physical coupling or connection and, instead, should be read to include communicative couplings, including wireless transmissions and protocols.

Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e. within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g. one or more of A, B, and/or C), unless stated otherwise, it is understood to include one or more of each element, including any one or more combinations of any number of the enumerated elements (e.g. A, AB, AC, ABC, ABB, etc.). When “and/or” is used, it should be understood that the elements may be joined in the alternative or conjunctive.

1. Apparatus for communicating information between at least two of a consumer user, an installer user or a vendor regarding distributed generator (DG) systems, comprising:
a communications manager comprising at least one processor coupled to at least one non-transitory computer readable media, where the at least one non-transitory computer readable media contain instructions that, when executed by the at least one processor, cause the communications manager to perform the following operations:
estimating components required to create, upgrade or add to a DG system;
selecting, based at least in part on the estimated components, at least one installer user capable of installing the components;
communicating the estimated components and the at least one selected installer user to a consumer user;
communicating a selection of at least one specific installer user from the at least one selected installer user to the at least one selected specific installer user;
communicating a request for quote and the estimated components to the t least one selected specific installer user;
communicating, in response to the request for quote, a quote to the consumer user;
communicating an acceptance of the quote to the selected recommended DG system installer; and
communicating a status bar to the selected recommended installer user and the consumer user, where the status bar represents progress made during the operations.

2. The apparatus of claim 1, wherein estimating further comprises utilizing a location and facility size of the consumer user.

3. The apparatus of claim 1, further comprising determining whether the estimated components are for a turnkey DG system and, based on the determination, selecting at least one installer user capable of installing a turnkey DG system.

4. The apparatus of claim 3, further comprising providing a link to a vendor on-line store if the estimated components are not for a turnkey system.

5. The apparatus of claim 1, further comprising providing a link to a vendor on-line store if the estimated components are for an upgrade or an addition to an existing DG system.

6. The apparatus of claim 1 further comprising monitoring an amount of time elapsed after communicating a request for quote and, if the time elapsed amount is greater than a time limit, communicating to the consumer user that the time limit has been exceeded.

7. The apparatus of claim 1 further comprising monitoring an amount of time elapsed after communicating a quote and, if the time elapsed amount is greater than a time limit, communicating to the installer user that the time limit has been exceeded.

8. The apparatus of claim 1 further comprising communicating, upon acceptance of the quote, a contract for purchase and installation of a DG system to the consumer user and the installer user.

9. A method of communicating information between at least two of a consumer user, an installer user or a vendor regarding distributed generator (DG) systems, comprising:
estimating components required to create, upgrade or add to a DG system;
selecting, based at least in part on the estimated components, at least one installer user capable of installing the components;
communicating, via a communications manager, the estimated components and the at least one selected installer user to a consumer user;
communicating, via a communications manager, a selection of at least one specific installer user from the at least one selected installer user to the at least one selected specific installer user;
communicating, via the communications manager, a request for quote and the estimated components to the selected specific installer user;
communicating, via the communications manager, in response to the request for quote, a quote to the consumer user;
communicating, via the communications manager, an acceptance of the quote to the selected specific installer user; and
communicating, via the communications manager, a status bar to the selected specific installer user and the consumer user, where the status bar represents progress made during the operations.

10. The method of claim 9, wherein estimating further comprises utilizing a location and facility size of the consumer user.

11. The method of claim 9, further comprising determining whether the estimated components are for a turnkey DG system and, based on the determination, selecting at least one installer user capable of installing a turnkey DG system.

12. The method of claim 11, further comprising providing a link to a vendor on-line store if the estimated components are not for a turnkey system.

13. The method of claim 9, further comprising providing a link to a vendor on-line store if the estimated components are for an upgrade or an addition to an existing DG system.

14. The method of claim 9 further comprising monitoring an amount of time elapsed after communicating a request for quote and, if the time elapsed amount is greater than a time limit, communicating to the consumer user that the time limit has been exceeded.

15. The method of claim 9 further comprising monitoring an amount of time elapsed after communicating a quote and, if the time elapsed amount is greater than a time limit, communicating to the installer user that the time limit has been exceeded.

16. The method of claim 9 further comprising communicating, via the communications manager, upon acceptance of the quote, a contract for purchase and installation of a DG system to the consumer user and the installer user.

17. One or more non-transitory computer readable media for storing instructions that, when executed by at least one processor cause the at least one processor to perform operations for communicating information between at least two of a consumer user, an installer user or a vendor regarding distributed generator (DG) systems, the operations comprising:
estimating components required to create, upgrade or add to a DG system;
selecting, based at least in part on the estimated components, at least one installer user capable of installing the components;
communicating the estimated components and the at least one selected installer user to a consumer user as a recommended DG system installer;
communicating a selection of at least one specific installer user from the at least one selected installer user to the at least one selected specific installer user;
communicating a request for quote and the estimated components to the selected specific installer user;
communicating, in response to the request for quote, a quote to the consumer user;
communicating an acceptance of the quote to the selected specific installer user; and
communicating a status bar to the selected recommended installer user and the consumer user, where the status bar represents progress made during the operations.

18. The one or more non-transitory media of claim 17, wherein the estimating operation further comprises utilizing a location and facility size of the consumer user.

19. The one or more non-transitory media of claim 17, the operations further comprising determining whether the estimated components are for a turnkey DG system and, based on the determination, selecting at least one installer user capable of installing a turnkey DG system.

20. The one or more non-transitory media of claim 17, the operations further comprising providing a link to a vendor on-line store if the estimated components are not for a turnkey system.

21. The one or more non-transitory media of claim 17, the operations further comprising providing a link to a vendor on-line store if the estimated components are for an upgrade or an addition to an existing DG system.

22. The one or more non-transitory media of claim 17, the operations further comprising monitoring an amount of time elapsed after communicating a request for quote and, if the time elapsed amount is greater than a time limit, communicating to the consumer user that the time limit has been exceeded.

23. The one or more non-transitory media of claim 17, the operations further comprising monitoring an amount of time elapsed after communicating a quote and, if the time elapsed amount is greater than a time limit, communicating to the installer user that the time limit has been exceeded.

24. The one or more non-transitory media of claim 17, the operations further comprising communicating, upon acceptance of the quote, a contract for purchase and installation of a DG system to the consumer user and the installer user.
